(19) United States
(12) Patent Application Publication
(10) Pub. No.: US 2012/0044362 A1
(43) Pub. Date: Feb. 23, 2012

(54) METHODS AND SYSTEMS FOR PROCESSING DIGITAL CAMERA EXPOSURES IN A NETWORK

(75) Inventor: Werner KRACHTUS, Bechtsrieth (DE)

(73) Assignee: MOTIONDRIVE AG, Neustadt a.d. Waldnaab (DE)

(21) Appl. No.: 12/859,226

(22) Filed: Aug. 18, 2010

(51) Int. Cl. H04N 5/225

(52) U.S. Cl. 348/207.1; 348/E05.024

(57) ABSTRACT

The present disclosure comprises a system for processing digital camera exposures that includes a network, such as a global network like the internet, and one or more digital single-use cameras. A plurality of user stations are connected to a provider station. The provider station can provide functionalities enabling the user to process the pictures, to select pictures, to order selected pictures, to order a photobook or an album including selected pictures, etc. that were taken with the digital single-use camera.

### BACKGROUND

The present disclosure relates to methods and systems for processing digital camera exposures that may comprise a network including a provider station for providing digital processing services and at least one user station connected to the provider station, and at least one digital camera.

Conventional single-use or disposable cameras have been available in the market for quite a long time. The cameras may be sold in any kind of shop or outlet location.

They are simply constructed, comprise simple components and are relatively cheap. Usually, single-use or disposable cameras are box cameras with a roll of film installed. Most of them use focus free lenses. Usually they have an inbuilt flash light.

Often they are distributed and used at particular occasions such as celebrations or weddings. There are also cameras available having a watertight housing. They may be used under water for underwater photography while snorkeling or diving. The cameras are particularly popular in situations where a reusable camera would be easily stolen or damaged.

After taking a predetermined number of photographs the whole camera is sent to a laboratory for processing, i.e., for developing the film and producing photographs. Because the film cannot be changed the housing is opened in the laboratory. After developing the film the photographs are sent back to the user. The opened cameras are usually disposed, only some of them are recycled, i.e. refilled with film and resold.

However, although the cameras are cheap and handling is easy, there are some serious drawbacks. Due to the use of cheap components, the quality of the photographs is not satisfactory. Furthermore, environmental aspects are not considered in this system as the camera may be made from different materials which may not be separated easily. Moreover, users may want to have more flexibility with respect to the products they obtain and more influence on the design of the product.

It is an object of the present disclosure to solve these problems, namely, to increase the quality of single-use cameras, to consider environmental aspects, and to provide customized products.

### SUMMARY

A system according to the present disclosure for processing digital camera exposures may comprise a network including a provider station for providing digital processing services, and at least one user station connected to the provider station; and at least one digital camera; wherein the provider station may store digital camera exposures taken with the digital camera.

In some embodiments of the present disclosure, the provider station may allow access to the digital camera exposures upon input of a user identifier. Allowing access may include presenting pictures to the user, allowing the user to download exposure data, to retrieve exposure data at the user station, process pictures, select pictures, etc.

A digital camera may be a camera for taking photographs, but it may also have a functionality of taking film sequences. Also, the camera may be a camcorder. It is noted that the term “camera” will be used for all these possibilities.

The user identifier may be any kind of unique identifier, e.g., a code provided by the provider to the user when the user acquires the “package” including a camera (provided on a loan basis) and additional services/products. The code may allow access to a private user access area in the provider station. (I.e., the provider may configure or define a private user access area for each customer which is only accessible by entering the code). Later, after returning the camera to the provider, the pictures taken with the camera may be presented in the private user access area. The user can see the pictures, select pictures, process pictures, order products, etc., whatever functionalities the provider offers in the provider station. It is also possible that the private user access area may be used as a tool for exchanging messages and information between the provider and the user.

In another embodiment of the present disclosure, the user identifier may be generated by the user and notified to the provider. For example, the user, after having acquired the package, may send to the provider a personal or individual password. Then the provider may open a private user access area for the user and activate access upon entering the password.

In another embodiment of the present disclosure, the package may include as a user identifier a memory, e.g., an USB memory stick. The memory may have a particular identifier stored thereon. The identifier may be attributed to a (unique) serial number (maybe stored on an RFID chip arranged in the camera) of the camera included in the package. Thus an attribution of the stick and the camera may be made at any time. When accessing the private area provided by the provider for the camera with a particular serial number, the user may present the corresponding identifier stored in the memory stick.

In another embodiment of the present disclosure, a code or identifier may be provided in a message, e.g., e-mail, SMS, etc., and sent via a network, e.g., internet or a mobile phone network. As soon as the provider receives a camera from the user he may send a message that includes an identifier code to the user.

The user may access the data of his photographs which he/she had sent to the provider stored in a memory card of the camera. Therefore, it may be up to the user to amend, process, select, or arrange his/her photographs before ordering a product within the process of handling single-use digital cameras within a single-use digital camera system, i.e., the provider may integrate different services in one process.

The digital camera and the user code may be provided as a package or set before using the camera during a single use stage. When buying the package, the user may receive the code for access to his image data at a later stage. In another embodiment, the code may be provided at a later stage, for example, after the camera has been returned to the provider.

The provider station may provide to the user station tools for selecting retrieved digital camera exposures. Thus the user may make a selection of pictures which he/she wishes to include in his product. The product may be any kind of product including images. For example, the user may order a customized cup, T-shirt, photobook, etc.

The provider station may provide to the user station tools for ordering the selected digital camera exposures or a product including the selected digital camera exposures. In another embodiment of the present disclosure, software may be provided by the user station which selects a number of digital camera exposures/images according to predetermined criteria. For example, images may be filtered which are technically not acceptable, such as ones which do not comprise adequate brightness. Other criteria may be applied as well. This solution could be considered as an “intelligent software solution”.

The provider station may provide to the user station tools for processing the selected digital camera exposures.

The provider station may provide to the user station tools for arranging the selected digital camera exposures in a template.

The user station may comprise at least one of a notebook, a computer, and a mobile phone.

The connection between the user station and the provider station may be at least one of a wireless connection and a cable connection.

The digital camera may provide a limited number of exposures to be taken during a single use stage.

The digital camera may comprise a link for accessing the exposure data via the link, and a lock for preventing access to the link unless an access key is applied for unlocking the lock.

In another embodiment of the present disclosure, the digital camera may comprise an interface for accessing the exposure data via the interface, and a lock for preventing access to the interface unless an access key is applied for unlocking the lock.

The lock may comprise a housing which covers the link and the interface, respectively, and which is non-detachably fixed to the camera.

The housing may be watertight or waterproof.

The housing may be disposable.

Furthermore, it is possible that the housing has a customized design.

The digital camera may comprise a functionality of taking film sequences. It may have both functionalities, namely taking pictures and recording films or it may be a digital camcorder.

The camera may be a single-use camera or a reusable camera having a limited number of exposures to be taken during a single-use stage or a limited recording time for film sequences to be taken during a single-use stage. A reusable camera may be used in several subsequent cycles of a single-use application.

A system for processing digital camera exposures may comprise: a network that may include a provider station for providing digital processing services, and at least one user station connected to the provider station; and at least one single-use digital camera for taking a limited number of exposures during a single-use stage; wherein the provider station may encode and store digital camera exposure data referring to exposures taken by the single-use digital camera.

Others embodiments of the present disclosure for processing digital camera exposures may comprise: a provider for providing digital processing services, and at least one user, wherein the provider may provide a set of a single-use digital camera and an access code for enabling the user to access digital camera exposure data stored in a central memory.

A method for processing digital camera exposures according to the present disclosure may comprise: a. providing a set of at least a digital single-use camera and an access code; b. returning the digital single-use camera to a provider after taking exposures with the camera; c. storing exposure data of the exposures taken with the camera; d. providing access to the exposure data upon transmission of the access code to the provider; and e. providing processed exposure data or processed pictures.

The processed exposure data may be provided as data stored on a recording medium such as a DVD, a CD, online in a print format, or as printed hardware, e.g., a photobook or printed items like cups, T-shirts, etc.

In some embodiments, method step a. may comprise providing a plurality of digital single-use cameras in the set.

The camera may be provided in a receptacle which is provided for returning the digital single-use camera to the provider after taking exposures with the camera. The receptacle may be an envelope, a bag, a pouch, a case, a package, etc.

Another method of providing digital photography services to a user according to the present disclosure may comprise a provider offering in combination a. a digital camera or digital camcorder for taking photographs or film sequences during a single-use phase; and b. at least one of digital photography processing services and a product based on the photographs taken by the user and returned to the provider.

The price for an offer (package) may substantially correspond to the price of the services/products included in the offer. However, the services/products that may be included in the offer may only be claimed after returning the camera or camcorder to the provider. Thus, the price paid for the package before claiming the services/products may include in the offer a deposit for the camera. Therefore, there may be a high incentive to return the camera to the provider after a single-use phase. The camera may be left to the user free of charge (or for a certain amount for renting the camera) for a single-use range. The provider may “lend” the camera to the user when selling the package upon a deposit which may be the price for the services. It may be a feature of the present disclosure that the provider does not make a loss even when the user keeps the camera, hacks the camera etc. The value of the camera/camcorder and the value of the services/products may substantially correspond. Small variations of the price, e.g., for compensating for administrational cost, additional charge for risk of having to repair or replace cameras, etc., may be within the scope of the present disclosure. However, the user may have the feeling that he does not pay at all for the camera, but only for the services which he converts in exchange for the camera after his/her particular single-use phase.

Another aspect of the present disclosure may be that the provider of the camera/camcorder is also the provider of the services/products acquired together with the camera/camcorder. In conventional systems, a disposable camera could be sent to any laboratory for developing the film. The laboratory may have charged extra for their services. In the present disclosure, selling the package may include providing a camera on a loan basis and selling digital photography services like printing books. All the steps may be carried out and administered by the same provider, i.e., the system and method may be a closed circuit. A single-use cycle system and method are provided, wherein the cameras may circulate to be used during single-use cycles. The plurality of cameras may be circulated in the closed circuit. For example, a first part of the plurality of cameras may be distributed among another plurality of users taking photos in their particular single-use phase. Another part of the plurality of cameras may have been returned from users to the provider for producing selected items or for carrying out selected services. Another part of the plurality of cameras may have been reset for another single-use phase and offered in a shop or in any other sales location to customers who are interested in acquiring the package of camera and other products/services. In the closed circuit there may be just a single payment transaction when the user buys the package.

Furthermore, the method may combine services and advantages of single-use cameras and digital photography services, e.g., ordering a photobook, in a very simple manner. A user may make a decision about the product when buying the package, e.g., when there is a choice of different packages for different services, he/she may make a decision when returning the camera to the provider by filling in an order card, and/or after retrieving (and selecting/processing) the data in the provider's access area in a global network.

The single-use phase may be defined by a restriction of the number of photographs to be taken with the camera or the exposure time for film sequences to be taken with the camcorder. The digital camera or the digital camcorder may have a limited capacity of exposures and recording time, respectively, during a single-use phase. The camera may be a single-use camera or a reusable camera having a limited number of exposures to be taken during a single-use stage or a limited recording time for film sequences to be taken during a single-use stage. In another embodiment of the present disclosure, the capacity of the camera/camcorder may be limited by the charge state of the power source, e.g., the accumulator, battery, rechargeable battery, etc. As long as the power source is charged, exposures and films may be taken. If the charge state is “empty” the camera may have to be returned because the camera may be configured that the user is not enabled to re-charge the power source or change the battery. For example, the battery may be integrated within the housing of the camera without access for the user. The power source and the other technical components may be encapsulated in the housing. In another embodiment of the present disclosure, a set of power sources that are particularly suitable and fitting in the camera may be provided at the time of acquiring the camera.

One or all the cameras circulating in the closed circuit of the system/method according to the present disclosure may include an ID chip, e.g., RFID chip, or any other identification device such that the pictures taken and returned to the provider by a particular user can be unambiguously attributed to the user. As pictures may be considered very private and personal it may be important to avoid any confusion of users and picture sets. An ID chip which is connected with the camera may allow for identifying a set of image data when the camera is returned to the provider until the product is sent to the user. The system may be configured such that an order form filled in by a user (or any personal data, e.g., name, address, etc., provided by the user) may comprise a first code and the ID chip may comprise the same or another code which is attributed to the first code. Thus, customer/user data and a camera returned by this particular customer/user may always be attributed to the personal data of the user although during the technical process the camera may be separated from the order form or from the data provided by the user.

In some embodiments of the present disclosure, the digital camera or the digital camcorder may be a multi-use camera and a multi-use camcorder, respectively, which may be used in several subsequent single-use stages/phases, i.e., in several subsequent cycles of single-use application. Thus, the quality of the components may be improved compared with disposable cameras. Furthermore, an improvement may be achieved by digital technology and processing. Furthermore, “recycling” may be very easy because it is accomplished by simply providing memory space for the next single-use stage. This can be done by deleting data from a memory or by resetting the camera.

A software solution may be implemented in the logical circuit of the camera. It may deny user access to the internal memory of the camera or it may encode exposure data stored in the internal memory of the camera. Only the provider may be able to deactivate the blocking or to decode the data.

A hardware solution may comprise a mechanical blocking of a link or an interface provided in the camera. Whereas the internal memory of the camera may be blocked against access by the user, the provider may have a “key” to unlock the download functionality. For example, the “key” may be a tool for breaking or opening the housing of the camera in order to obtain access to the memory card, a link, an interface, etc. However, the housing may just be an encapsulation which may be opened by applying force, or by applying a special tool for opening, e.g., screws or bolts, to open the housing. Another possibility is that the housing may be destroyed by the provider in order to be able to access the memory and the housing may be replaced for the next single-use stage (i.e., the housing may be a single-use housing, whereas the other components of the camera are multi-use components).

In some embodiments of the present disclosure, the method may include providing in said combination a voucher for claiming said photography processing services and said product.

The product may include that a photograph taken is provided as data stored on a recording medium such as a DVD, a CD or online in a print format. Or the product may be printed matter, e.g., a photobook, an album, etc.

The digital camera and the digital camcorder, respectively, may be offered in a receptacle or together with a receptacle for receiving the digital camera and digital camcorder, respectively, after termination of the single-use phase, and returning it to the provider. After having taken pictures, the user may return the camera to the provider. The receptacle may comprise a field, e.g., including a stamp, indicating that the correct postage has been paid (which may be included in the purchase price for the offer).

Payment of the combination may be effected at the time or before the time of handing over the camera and camcorder, respectively, to the user so that the user may not pay for the camera directly, but for the services/products included in the offer. The purchase price may be used as (or include) a deposit for the camera until it is returned to the provider, i.e., the user may have to return the camera or camcorder before claiming digital photography processing services and a product included in the offer.

The camera may have a functionality of taking photographs and film sequences. The offer may be adapted to this functionality by providing a camera which is configured for recording a combination of pictures and film sequences until a predetermined capacity is used.

A system of providing digital photography services to a user may comprise a provider offering in combination a. a digital camera or digital camcorder for taking photographs or film sequences during a single-use phase; and b. at least one of digital photography processing services and a product based on the photographs taken by the user and returned to the provider; wherein the provider may have a camera distribution unit for distributing cameras in a distribution system, a receiving unit for receiving cameras returned by the users, a processing unit for processing exposure data provided by the users, and a memory for storing exposure data.

### BRIEF DESCRIPTION OF THE DRAWINGS

FIG. 1 illustrates a schematic view of a system according to the present disclosure.

FIG. 2 illustrates a flow chart showing a method according to the present disclosure.

FIG. 3 illustrates a schematic view of another system according to the present disclosure.

FIG. 4 illustrates a flow chart showing another method according to the present disclosure.

### DETAILED DESCRIPTION

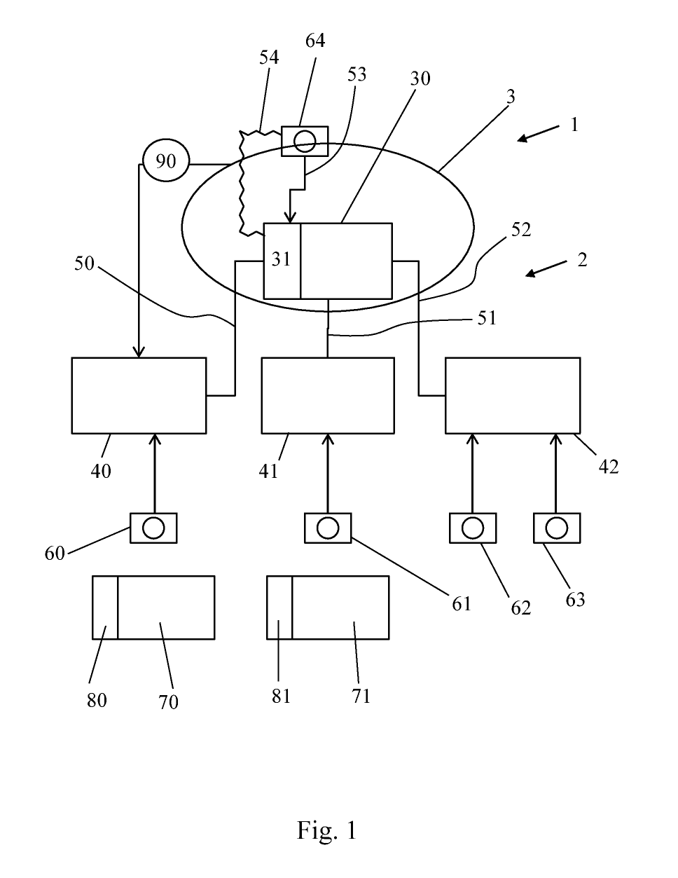

Reference is made to FIG. 1 showing a schematic view of a system according to the present disclosure. System 1 may comprise a network 2, e.g., a global network like the internet, and a provider 3.

The provider 3 may have a provider station 30 which is included in the network 2. Furthermore, the network 2 may comprise a plurality of user stations 40, 41, 42 which may be connected to the provider station 30 via cable connections 50, 51, and 52, respectively. However, in another embodiment of the present disclosure the connections may be wireless connections.

The user stations 40, 41, 42 may be computers, mobile phones, notebooks or any other electronic device being connected to the provider and having a user interface.

The system 1 may comprise a plurality of digital cameras 60, 61, 62, 63, and 64. Cameras 60, 61, 62 and 63 may be attributed to users 40, 41, and 42, respectively, as indicated by arrows. A further camera 64 may be just connected to the provider station 30.

The digital cameras 60, 61, 62, 63 and 64 may be designed to be used in a single-use stage, i.e., each of the cameras 60, 61, 62, 63 and 64 may have a limited number of exposures to be taken before the camera is sent to the provider 3. For example, the number of exposures may be limited to 24 or 36 exposures. After the maximum number of exposures has been taken, the camera may be disabled to take any further pictures The number of exposures may be limited by software implementation or by a limitation of the capacity of the memory card of the camera.

The cameras may be disposable cameras. The cameras may also be re-usable after a single-use range for a next single-use range, i.e., the cameras may form a system of reusable cameras. After the data have been transferred from the memory of the camera to the memory 31 of the provider station 30, the memory of the camera may be deleted to provide memory for the next (and sometimes limited) number of exposures. It may also be possible to activate the memory for a new single-use range and thus enable the memory to overwrite data stored in the memory of the camera.

Furthermore, the cameras 60, 61, 62, 63 and 64 may be configured to prevent access to the memory of the camera. For example, the cameras 60, 61, 62, 63 and 64 may be configured to prevent transfer or downloading of the exposure data from the memory. This configuration may be implemented by providing no accessible interface or link for connecting the camera to an external memory. In another embodiment, the interface or link may be locked in order to prevent users from accessing data stored in the camera.

Only the provider 3 may be able to access and download the stored data to a memory 31 of the provider station 30 as shown in FIG. 1 with respect to camera 64. The data transfer may be enabled by unlocking an interface or a link. Unlocking may be provided by changing settings in the software of the camera, by unlocking a mechanical lock, e.g., by opening a cover portion of the housing or by destroying the housing of the camera, etc. Furthermore, the data stored in the camera may be encoded. Only the provider may be able to decode the data after a data transfer to memory 31. The data transfer may be accomplished by a cable connection 53 or wireless, e.g., by wireless LAN 54. Any encoding/decoding method may be considered to provide a lock for disabling unauthorized users to transfer data. If image data are stored as encoded data in the memory of the camera, a further advantage may be that in case of loss of the camera there is no risk that the images may be seen by uninvolved persons.

Furthermore, the system 1 may comprise receptacles 70, 71, e.g., a box, a bag or a pouch, provided with the cameras 60 and 61, respectively. The cameras 60, 61 may be received in one of the receptacle 70, 71 when being acquired by a user 40, 41. In the receptacle 70, 71, there may be a code 80, 81 or a voucher 80, 81. The code 80, 81 may allow accessing the provider station 30 to retrieve pictures taken with camera 60 and 61, respectively, from the memory 31 of the provider station 30. The provider station 30 may provide further functionalities enabling the user to process the pictures, to select pictures, to order selected pictures, to order a photobook or an album including selected pictures, etc. The code or voucher 80, 81 may be used to order printed photographs or a recording medium 90 such as CD or DVD with the photographs recorded thereon in a print format. The recording medium may also include software for further processing the photographs.

In some embodiments, system 1 may be for processing digital camera exposures and may comprises a network 2, e.g., a global network like the internet. A plurality of user stations 40, 41, 42 may be connected to a provider station 30 via cable connections 50, 51, and 52, respectively. Furthermore, the system 1 may comprise a plurality of digital single-use cameras 60, 61, 62, 63, and 64. The provider station 30 may provide functionalities enabling the user to process the pictures, to select pictures, to order selected pictures, to order a photobook or an album including selected pictures, etc.

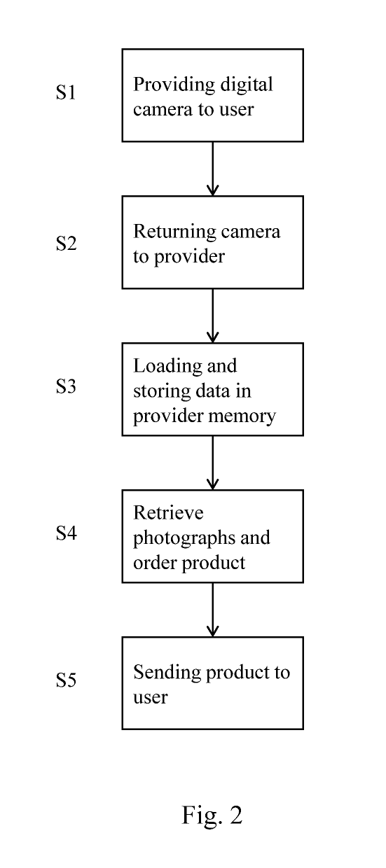

FIG. 2 illustrates a method according to the present disclosure.

In a step S1, a provider may provide, e.g., in a shop, digital cameras to be acquired by users. The camera may be received in a receptacle which also includes a code and/or a voucher. Instead of a single camera, a set of cameras may be offered to the user. When the user pays for the camera, he/she may acquire a package of goods/services that include processing of the pictures by the provider as well as producing and sending products such as photobooks, printed matter, or other items (like cups, T-shirts, etc.), including selected photographs taken with the camera.

In a step S2, after the user has taken a (perhaps limited) number of photographs, the camera may be returned to the provider. The provider may load and store, in a step S3, image data from the camera to a provider memory.

In a step S4 the user may, via a user station, retrieve the image data sent to the provider upon entering the code. He may select a number of photographs, create a photobook or an album, process the images, etc. Afterwards, he may order particular products, e.g., a photobook, printed hardware, a data storage medium such as a CD or a DVD, including the selected photographs. The order may be sent directly via the network after logging in the access area of the provider station by entering the code. Alternatively, the voucher may be cashed for ordering the product.

In a step S5, the ordered product may be produced and sent to the user. Alternatively, the product may be provided online to be downloaded by the user and printed out or stored at the user station.

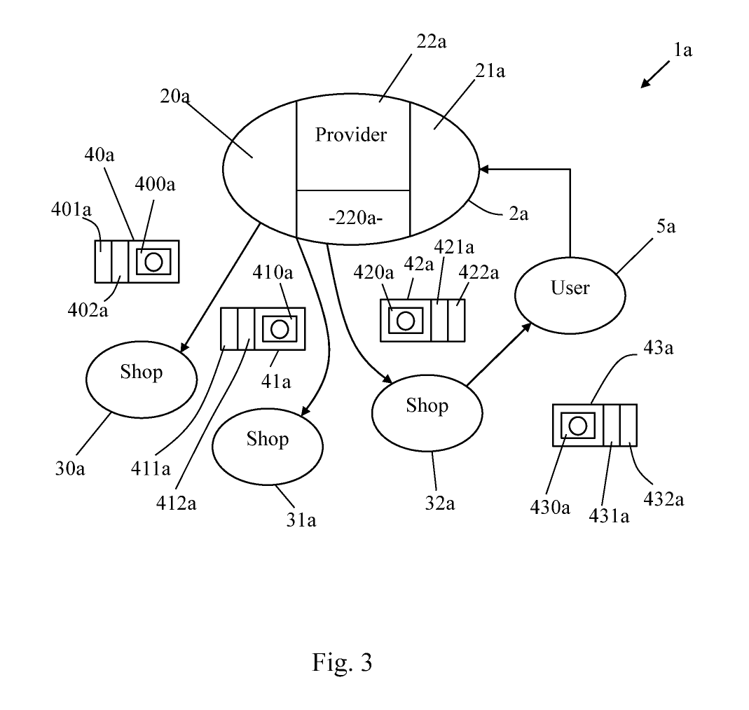

FIG. 3 shows a schematic view of a system 1a for offering digital photography services in combination with a single-use digital camera according to the present disclosure. The system 1a may comprise a provider 2a and a distribution system 3a.

The provider 2a may have various functional units or departments 20a, 21a, 22a. A camera distribution unit 20a may distribute digital cameras and/or digital camcorders 400aa, 410a, 420a to a distribution system 3a (which may include shops 30a, 31a, 32a). A receiving unit 21a may receive cameras returned by a user 5a to the provider, e.g., by post. A processing unit 22a (including a central memory 220a) may process image data taken and provided by the users 5a by returning the cameras to the provider 2a.

According to the present disclosure the cameras 400a, 410a, 420a, 430a may be offered and provided by the provider 2a in a combination 40a, 41a, 42a, 43a with digital processing services for processing digital pictures and/or a product, e.g., a printout of the photographs, a photobook, a recording medium such as DVD, CD with print data of the photographs. The product may also be a downloadable print version of the photographs. Thus, the offer may include a package 40a, 41a, 42a, 43a of a camera/camcorder (or a set of cameras/camcorders) 400a, 410a, 420a, 430a with a claim for additional goods/services. The services and products that may be included in the offer are schematically indicated by vouchers 401a, 411a, 421a and 431a included in each of the packages 40a, 41a, 42a, 43a which may entitle the user to claim the services/products included in the offer.

The cameras 400a, 410a, 420a, 430a that may be included in the packages 40a, 41a, 42a, 43a may be single-use cameras or camcorders in the sense that “single-use” refers to single use for a user in a particular single-use phase. The reason is that the number of pictures to be taken by a camera 400a, 410a, 420a, 430a or the time for taking film sequences with a camcorder of a package 40a, 41a, 42a, 43a may be limited. Also, it may not be possible for a user to download or transfer exposures stored on a memory card of a camera/camcorder to an external memory as with conventional multi-use cameras. This does not mean that the cameras or camcorders 400aa, 410a, 420a, 430a are necessarily disposable. The cameras or camcorders 400a, 410a, 420a, 430a may be multi-use devices and they may be configured for repeatable single-use phase application. As soon as a single-use phase is terminated, i.e., the memory capacity has been used and there is no more memory capacity available, the camera may have to be reset in order to be used in a next single-use phase. Only the provider may be enabled and entitled to transfer data from the camera to an external memory and to reset the camera.

Furthermore, a return receptacle, e.g., an envelope, bag, pouch, or case 401a, 411a, 421a, 431a may be included in the package 40a, 41a, 42a, 43a to receive the camera after use, and to return it to the provider 2. The receptacle 401a, 411a, 421a, 431a may include the postage for returning the receptacle 401a, 411a, 421a, 431a from a user 5a to the provider.

The distribution system 3 may have a plurality of shops 30a, 31a, 32a. The shops 30a, 31a, 32a (including various sales or distribution outlets) may sell the packages 40a, 41a, 42a, 43a. The price for a package 40a, 41a, 42a, 43a may correspond to the price of the services/products included in the offer. However, the services/products included in the offer may only be claimed after returning the camera or camcorder 400a, 410a, 420a, 430a to the provider. Thus, the price paid for the package before claiming the services/products may include in the offer a deposit for the camera. Therefore, there may be a high incentive to return the camera to the provider after a single-use phase. The camera may be left to the user free of charge (or for a certain amount for renting the camera) for a single-use range. The provider may lend the camera to the user when selling the package 40a, 41a, 42a, 43a.

Instead of shops, or in addition to shops, vending machines may be included in the system where the user can buy cameras or camcorders. The cameras may be sold with a choice of different products. For example, the camera may be bought in connection with a photobook, a photo album, a T-shirt, a cup or any other item including an illustration of one or a plurality of photos taken with the camera. There may be the possibility, however, to select the kind of service/product later.

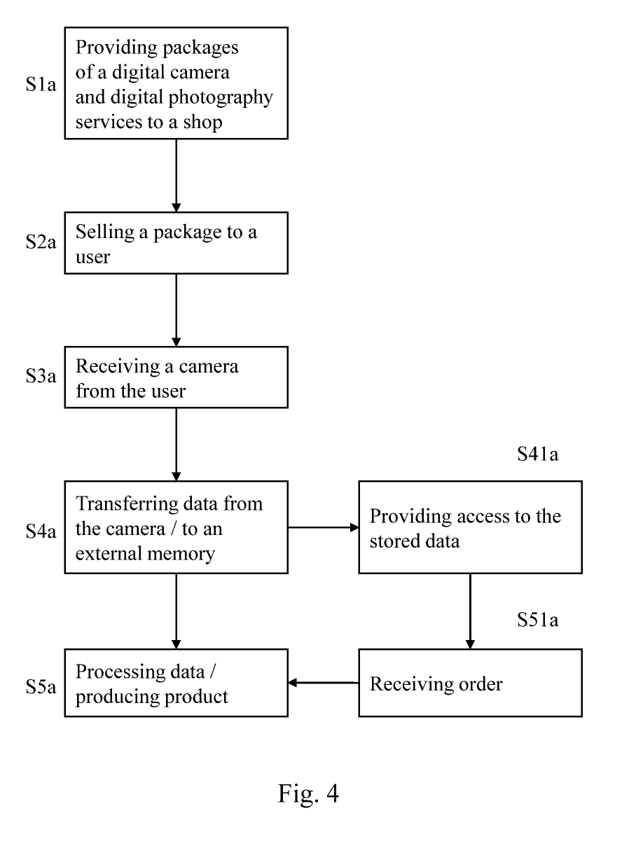

FIG. 4 illustrates a method of providing digital photography services and products to a user according to the present disclosure.

In a step S1a, a provider may provide, e.g., to a shop, packages including at least one digital camera and/or digital camcorder, and digital photography services and/or the right to order digital photography products after returning the camera. A voucher may be provided together with the camera, either in written form or as a code. As described above, the cameras and camcorders, respectively, included in the package may have limitations with respect to the capacity and with respect to the transfer of data from the internal memory card of the camera to an external memory. In other words, the transfer may be blocked for the user such that only the provider may have a “key” to transfer data and to reset the camera for another single-use phase.

In a step S2a, a package may be sold to a user. The user may pay for the package in the shop, e.g., in cash or by credit card. The payment may be simultaneously a deposit for the camera/camcorder and the purchase price for the services/products included in the package. Because the services/products may only be provided after the camera has been returned to the provider, the payment may be a deposit during the single-use phase and a purchase price after returning the camera to the provider. Thus, high quality components may be used for the camera resulting in high quality of the exposures.

In a step S3a, the user may send the camera back to the provider after having taken pictures during the single-use phase. The provider may receive the camera from the user.

In a step S4a, the provider may transfer the data relating to the exposures taken by the user from the internal memory card of the camera to an external memory. Because the internal memory of the camera may be blocked against access by the user, the provider may have a “key” to unlock the download functionality. The key may be any means to retrieve usable data from the memory. For example, the “key” may be a tool for breaking or opening the housing of the camera in order to obtain access to the memory card, a link, an interface, etc. The key may also be a code, e.g., for opening a cover part of the housing, for releasing a link or interface, or for decoding (encoded) data downloaded from the internal memory of the camera.

If image data are stored as encoded data in the memory of the camera, a further advantage may be that in case of loss of the camera there is no risk that the images may be seen by uninvolved persons.

In step S5a, the data may be processed by the provider. For example, the provider may generate data of the photographs and send them to the user on a CD or DVD in a printable format, e.g., as a collection of photographs in a (virtual) book. The data may also be processed and a corresponding product, e.g., printed matter (hardware), a photobook or photo album may be provided and sent to the user.

In another embodiment of the present disclosure, additional steps S41a and S51a may be included. In step S41a, which may be after step S4a, the provider may provide the stored data to the user, e.g., by presenting the pictures in a protected area of a memory. The user may, via the internet, by inputting a code which he/she may have received when buying the package, enter the protected area. Then he/she may select pictures to be processed, select a format or product he/she would like to order, and make a corresponding order. Furthermore, the user may be enabled to pre-process the pictures, e.g., determine the size and arrangement in a photobook.

In step S51a the user may release a data set and give an order.

Then the method may proceed to step S5a. The released data may be processed by the provider and/or selected products may be produced.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

We claim:

1. A system for processing digital camera exposures, comprising:
a network including a provider station for providing digital processing services, and at least one user station connected to the provider station; and
at least one digital camera;
wherein said provider station stores digital camera exposures taken with said digital camera.

2. The system of claim 1, wherein said provider station allows access to said digital camera exposures upon input of an individual user identifier.

3. The system of claim 2, wherein said digital camera and said user identifier are provided as a set before using the camera during a single use stage.

4. The system of claim 2, wherein said user identifier is a code provided by a provider to a user or generated by the user and notified to the provider.

5. The system of claim 1, wherein said provider station provides to said user station tools for selecting retrieved digital camera exposures.

6. The system of claim 5, wherein said provider station provides to said user station tools for ordering said selected digital camera exposures or a product including said selected digital camera exposures.

7. The system of claim 5, wherein said provider station provides to said user station tools for processing said selected digital camera exposures.

8. The system of claim 5, wherein said provider station provides to said user station tools for arranging said selected digital camera exposures in a template.

9. The system of claim 1, wherein said user station comprises at least one of a notebook, a computer, and a mobile phone.

10. The system of claim 1, wherein said connection between said user station and said provider station is at least one of a wireless connection and a cable connection.

11. The system of claim 1, wherein said digital camera provides a limited number of exposures to be taken during a single use stage.

12. The system of claim 1, wherein said digital camera comprises a link for accessing data, including said stored digital camera exposures, via said link, and a lock for preventing access to said link unless an access key is applied for unlocking said lock.

13. The system of claim 12, wherein said lock comprises a housing which covers said link, and which is non-detachably fixed to said camera.

14. The system of claim 1, wherein said digital camera comprises an interface for accessing data, including said stored digital camera exposures, via said interface, and a lock for preventing access to said interface unless an access key is applied for unlocking said lock.

15. The system of claim 14, wherein said lock comprises a housing which covers said interface, and which is non-detachably fixed to said camera.

16. The system of claim 15, wherein said housing is watertight.

17. The system of claim 15, wherein said housing is disposable.

18. The system of claim 15, wherein said housing has a customized design.

19. The system of claim 1, wherein said digital camera comprises a functionality of taking film sequences.

20. The system of claim 1, wherein said camera is a single-use camera or a reusable camera having a limited number of exposures to be taken during a single-use stage or a limited recording time for film sequences to be taken during a single-use stage.

21. A system for processing digital camera exposures, comprising:
a network including a provider station for providing digital processing services, and at least one user station connected to said provider station; and
at least one single-use digital camera for taking a limited number of exposures during a single-use stage;
wherein said provider station encodes and stores digital camera exposure data referring to exposures taken by said single-use digital camera.

22. The system of claim 21, further comprising a provider for providing digital processing services, and at least one user, wherein said provider provides the at least one single-use digital camera and an access code for enabling said user to access digital camera exposure data stored in a central memory.

23. A method for processing digital camera exposures, comprising the steps:
providing a set of at least a digital single-use camera and an access code;
returning said digital single-use camera to a provider after taking exposures with said camera;
storing exposure data of said exposures taken with said camera;
providing access to said exposure data upon transmission of said access code to said provider; and
providing processed exposure data or processed pictures.

24. The method of claim 23, wherein said processed exposure data are provided as data stored on a recording medium, a DVD, a CD, or online in a print format.

25. The method of claim 23, further comprising providing a plurality of digital single-use cameras in said set.

26. The method of claim 23, wherein said camera is provided in a receptacle which is provided for returning said digital single-use camera to said provider after taking exposures with said camera.
